(19) United States
(12) Patent Application Publication
(10) Pub. No.: US 2013/0179205 A1
(43) Pub. Date: Jul. 11, 2013

(54) SYSTEMS AND METHODS FOR OPTIMIZING TRANSPORTATION RESOURCES

(71) Applicant: Eduard SLININ, Holmdel, NJ (US)

(72) Inventor: Eduard SLININ, Holmdel, NJ (US)

(21) Appl. No.: 13/347,120

(22) Filed: Jan. 10, 2012

(51) Int. Cl. G06Q 10/04

(52) U.S. Cl. 705/7.13

(57) ABSTRACT

Systems and methods for optimizing transportation resources. The systems and methods include receiving, by a processor, a plurality of requests to pick up at a pick up location and drop off at a destination at least one item per request, storing the requests in a memory, and determining, by the processor, requests to be grouped in a vehicle to maximize at least one of vehicle and driver resources.

### TECHNICAL FIELD

The present disclosure generally relates to systems and methods related to scheduling of ground transportation services, and more specifically to systems and methods for optimizing transportation resources of ground transportation services.

### BACKGROUND

Ground transportation can include taxi, limousine, car and van services. Ground transportation providers provide services to pick up passengers at one or more locations and drop off the passengers at one or more destinations. Often, the ground transportation providers will combine the services for more than one client in a ride sharing process, that is, make more than one pick up stop and make more than one drop off stop to maximize vehicle and driver resources. Generally, a dispatcher receives requests from clients for pick up and delivery of passengers. After receiving the requests, the dispatcher must review all of the requests and attempt to dispatch the requests in this maximizing manner. As the number of requests, vehicles and drivers increases, this process of dispatching the requests can be overwhelming even to a seasoned dispatcher. Further, a driver must map out an entire route for multiple requests, a process that is both time consuming and prone to misuse of resources.

The description herein of problems and disadvantages of known systems, methods, and devices is not intended to limit the invention to the exclusion of these known entities. Indeed, embodiments of the invention may include, as a part of the embodiment, portions or all of one or more of the known apparatus, methods, and devices without suffering from the disadvantages and problems noted herein. This disclosure describes an improvement over these prior art technologies.

### SUMMARY OF THE INVENTION

Accordingly, systems and methods for optimizing transportation resources are provided.

In one particular embodiment, in accordance with the principles of the present disclosure, a method for optimizing transportation resources is provided. The method includes receiving, by a processor, a plurality of requests to pick up at a pick up location and drop off at a destination at least one item per request; storing the requests in a memory; and determining, by the processor, requests to be grouped in a vehicle to maximize at least one of vehicle resources and driver resources.

In one embodiment, in accordance with the principles of the present disclosure, a system for optimizing transportation resources is provided. The system includes a processor configured to receive a plurality of requests to pick up at a pick up location and drop off at a destination at least one item per request and determine requests to be grouped in a vehicle to maximize at least one of vehicle resources and driver resources; and a memory configured to store the requests.

In one embodiment, in accordance with the principles of the present disclosure, a computer program device readable by a machine, tangibly embodying a program of instructions executable by the machine to perform method steps for optimizing transportation resources is provided. The method steps include receiving a plurality of requests to pick up at a pick up location and drop off at a destination at least one item per request; storing the requests in a memory; and determining requests to be grouped in a vehicle to maximize at least one of vehicle resources and driver resources.

### BRIEF DESCRIPTION OF THE DRAWINGS

The present disclosure will become more readily apparent from the specific description accompanied by the following drawings, in which:

FIG. 1 is a block diagram of a system according to an embodiment of the present invention;

FIG. 2 is a flow diagram illustrating a process for optimizing transportation resources according to an embodiment of the present invention;

FIGS. 3A, 3B and 3C are flow diagrams illustrating a process for grouping requests;

FIGS. 4A, 4B and 4C are flow diagrams illustrating a process for routing requests; and

FIG. 5 is a flow diagram illustrating a process for updating requests.

Like reference numerals indicate similar parts throughout the figures.

### DETAILED DESCRIPTION OF THE INVENTION

The exemplary embodiments of the systems and methods for optimizing transportation resources are discussed. It is envisioned that the systems and methods for optimizing transportation resources can apply to other types of dispatching and/or distribution systems, including but not limited to ground transportation, air transportation and sea transportation.

The present invention may be understood more readily by reference to the following detailed description of the invention taken in connection with the accompanying drawing figures, which form a part of this disclosure. It is to be understood that this invention is not limited to the specific systems, devices, methods, conditions or parameters described and/or shown herein, and that the terminology used herein is for the purpose of describing particular embodiments by way of example only and is not intended to be limiting of the claimed invention. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

The following discussion includes a description of systems and methods for optimizing transportation resources, related components and exemplary methods of employing the systems and methods for optimizing transportation resources in accordance with the principles of the present disclosure. Alternate embodiments are also disclosed. Reference will now be made in detail to the exemplary embodiments of the present disclosure, which are illustrated in the accompanying drawings.

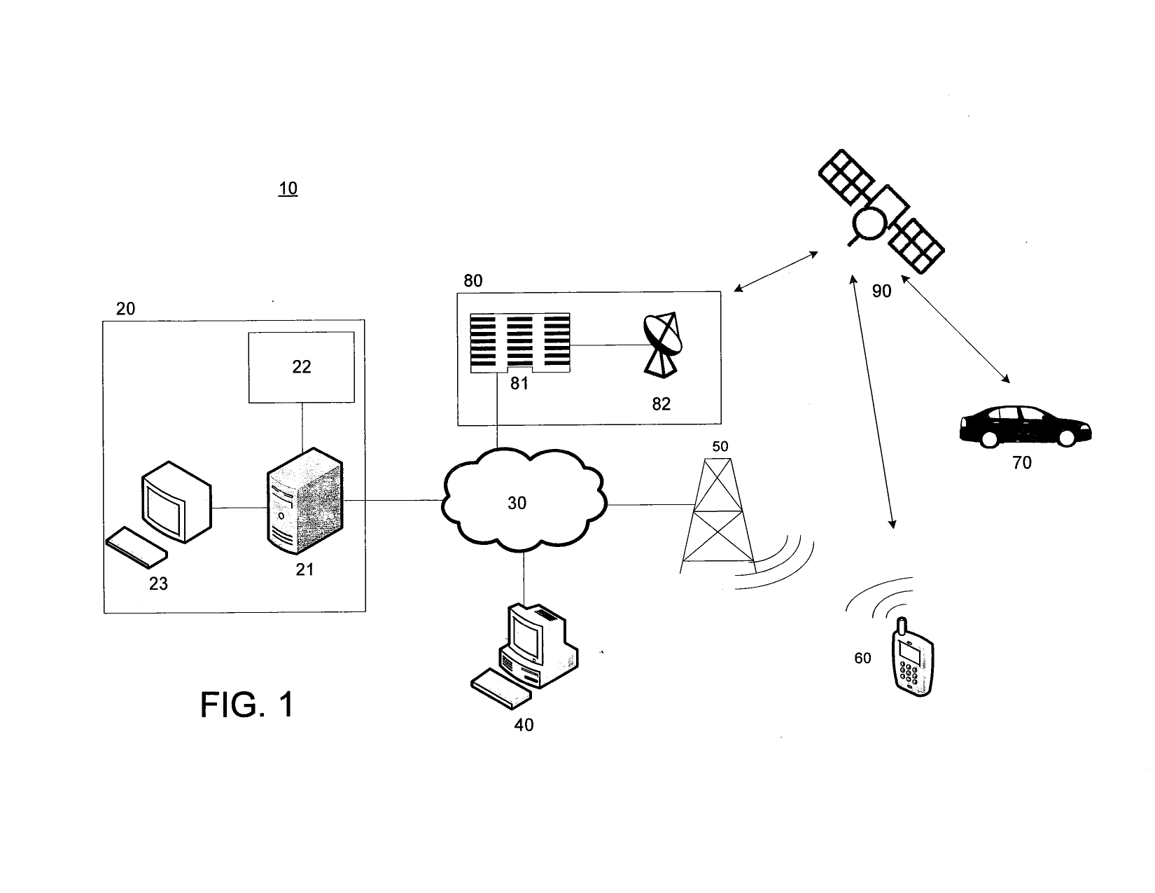

Turning now to FIG. 1, there is illustrated components of a system for optimizing transportation resources 10 in accordance with the principles of the present disclosure.

System for optimizing transportation resources 10 includes ride sharing system 20. Ride sharing system 20 includes a processor 21, a memory 22 and input/output device 23. Input/output device 23 can be any type of input device or output device, for example, a keyboard, a mouse, a display, a touch screen, a printer, etc. Other input/output devices are contemplated. Ride sharing system 20 is configured to receive from at least one client a request to pick up at least one item at a location and drop off the at least one item at a destination. The item to be picked up and dropped off can be objects or persons or a combination of both. In the following description, the item will be described as persons or passengers to be picked up and dropped off. Ride sharing system 20 is capable of taking these variations into consideration during the processes described herein.

Ride sharing system 20 is also configured to identify drivers who are available to be dispatched particular requests. Drivers are also referred to herein as driver resources. Ride sharing system 20 is configured to identify vehicles that are available for use to complete the requests. Vehicles are also described herein as vehicle resources. It is contemplated that different types of vehicles can accommodate different numbers of passengers. For example, a passenger van may be capable of accommodating a maximum of 12-15 passengers, while a town car can accommodate 1-3 passengers. It is also contemplated that certain vehicles can only be driven by certain drivers with appropriate training and/or licensing. Ride sharing system 20 is also configured to update requests during the processes described herein.

Ride sharing system 20 is configured to determine or schedule which passengers, i.e. requests, to dispatch to which drivers and in which vehicles in order to maximize the driver resources and vehicle resources. Ride sharing system 20 is configured to optimize this scheduling of driver resources and vehicle resources. In addition, ride sharing system 20 is configured to provide optimized routing for the scheduled requests. Ride sharing system 20 is configured to also identify requests that have not been scheduled and provide for additional dispatching for these requests that need dispatching; this additional dispatching can be made to in-house drivers and/or affiliates.

The general operation of the system for optimizing resources in ground transportation ride sharing 10 will now be described. Processor 21 receives a plurality of requests to pick up and drop off passengers. The requests can include a client identification (ID) for identifying a particular customer or client, a pick up location, a pick up time, a drop off destination, a drop off time and/or a number of passengers. When received, processor 21 stores the request in memory 22. In a simple system, requests can be received via telephone and manually entered via input device 23. In more complex systems, processor 21 is configured to be connected to network 30 and a client can log onto system 20 via network 30 (e.g. the Internet). Computer 40 is configured to be connected to network 30 and the client can submit to system 20 a request via computer 40. In another embodiment, a client can submit to system 20 a request via a cell phone 60 or other wireless device (e.g. a tablet computer, personal digital assistant (PDA), smart phone, etc.) through a wireless network 50. Although the wireless network 50 is depicted as a cell phone network, other wireless networks, for example, a Wi-Fi network, local area network (LAN), wide area network (WAN), are contemplated. A confirmation number for the submitted request can be generated by processor 21 and forwarded to the client who submitted the request.

Processor 21 is configured to perform a validation process on the request to determine if the pick up location and drop off destination addresses exist in a global positioning system (GPS) database, and determine price zones associated with the pick up location and drop off destination. The GPS database can be stored in memory 22 or located at a remote location and accessed by processor 21 via network 30. If the validation process cannot locate a GPS database match, a zip code can be used to determine the price zones. Other methods of converting a location or destination into GPS coordinates are contemplated. Processor 21 is configured to store the GPS coordinates and price zones for all received requests in memory 22. Processor 21 is configured to price out each request based on the price zones and store the prices in memory 22.

After requests are received, processor 21 is configured to group requests for dispatching to drivers. The grouping can be performed based on varying criteria. For example, a priority grouping, a standard grouping, a smart grouping and/or a manual grouping can be utilized.

The priority grouping groups requests based on priorities assigned to clients. For example, requests having a higher priority would increase grouping preferences.

The standard grouping can be based on pick up locations, travel distance and travel times. Processor 21 can check if two or more pick up locations are in close proximity from one another via GPS coordinates based distance calculation with a difference of pick up time of a configurable value. Processor 21 can then additionally calculate maximum travel time and exclude rides with appointment time exceeding the maximum drop off time. Once a group of rides qualify to be picked up with one vehicle, processor 21 sums up the number of passengers of all rides and assigns a vehicle type to the group. Processor 21 then scans the group for clients that have requested to or not to be assigned a certain vehicle type, and if found their rides will be removed from the group.

The smart grouping can group based, at least in part, on a determination that clients have been grouped in the past. This can be useful for repeat clients having repeating requests.

The manual grouping utilizes maps and forms to best group requests. Client preferences and number of passengers can be taken into account also during the manual grouping process.

The grouping processes will be further described herein below.

Processor 21 is also configured to receive status updates at anytime during the overall process. For example, if a cancellation request is received for a particular request, and the request has not been dispatched, the request will be removed from any further pre-dispatch processes. If the request has been dispatched, processor 21 will notify the driver to whom the request has been dispatched that the request has been cancelled and processor 21 is configured to then update previous routing and time schedules. In addition, if a new request is received by processor 21, and the new request can be scheduled into and existing group, whether dispatched or not, processor 21 is configured to add the new request into the group and update the grouping and/or dispatch as required.

System 20 is also configured to monitor and dispatch requests to in-house drivers and affiliates. Processor 21 is configured to store in memory 22 driver profiles. Processor 21 is configured to authenticate drivers and schedule drivers into dispatching. Processor 21 is configured to store in memory 22 types of vehicles available to certain drivers. Processor 21 is configured to determine is a driver is available for dispatch, based on location, driving time available, etc. Drivers can also be provided a driver application on a smart phone 60 (e.g. Blackberry®) with which processor 21 is configured to interact. Processor 21 is configured to track drivers through the GPS functions of smart phone 60 and/or GPS functions of vehicle 70 using a GPS system that includes a GPS base station 80 and a satellite 90. GPS base station 80 includes an antenna 82 and a GPS station 81 connected to network 30.

Processor 21 is configured to also provide point of service billing through the smart phone 60 using printers and credit card readers attached to the smart phone 60 (e.g. via a Bluetooth® connection). Processor 21 is configured to also display on input/output device 23 (e.g. a display) all of the requests, in and out of groups, client and driver information, request prices and total group dollar amounts. Processor 21 is configured to also track and limit the number of hours assigned to a particular driver or group of drivers (e.g. a particular affiliate). Processor 21 is also configured to permit drivers to browse available requests and groups and select requests and groups that best suit their resources.

Processor 21 is configured to store in memory 22 client profiles. In addition to standard information such as name, address and phone numbers, processor 21 is configured to store in memory 22 such things as client preferences, client Ids and/or repeat requests. Client preferences can include, for example, preferences to certain vehicle types (e.g. multi-passenger van, limo, town car, etc.) and/or grouping restrictions.

System 20 is configured to provide routing, scheduling and distribution functions. Processor 21 is configured to determine both routing types and routing methods for the requests in the groups. That is, processor 21 is configured to determine an optimized route for pick up and drop off of all passengers in a group. Routing types can include real time routing, fixed time routing and manual routing. Real time routing can include routing based on the actual time required to pick up and drop off a passenger, which can include traffic conditions, time of day, distance, etc. Fixed time routing can include routing based on a zone analysis of pick up locations and drop off destinations. Manual routing can include routing based on a routing form and a map to visualize an optimum route. During the routing process, a group is assigned a pick up time of the earliest pick up time of the requests in the group.

Routing methods can include a green routing method, a standard routing method and a base location routing method. In the green routing method, processor 21 applies routing by starting with a first request and determines a next request in the route based on the proximity of its pickup location in relation to the drop off location of the first request. Processor 21 performs this process recursively until the maximum number of requests or the maximum hours allowed per route is reached, whichever happens first. Processor 21 can utilize a configurable maximum idle time between requests in the route. Real time and fixed time routing can be used in the green routing method.

In the standard routing method, processor 21 applies routing by starting with a first request and determines a next request in the route based on its pick up zone and pickup time and the travel time of the previous ride and its drop zone; an adjustable sliding time window is used to increase the probability of finding an eligible request for the route. Additional sliding windows can be used to adjust for traffic conditions and/or weather conditions, as required. Processor 21 performs these processes recursively until the maximum number of requests or the maximum hours allowed per route is reached, whichever happens first. The standard method is only used when the green method routing has been exhausted.

In the base location routing method, processor 21 applies routing using the GPS coordinates of an affiliate's base location (e.g. location of operation). The distance from the GPS location of the base location and the pick up locations can be varied during the routing process.

Processor 21 loads all scheduling requests made by drivers and deploys all routing methods necessary to create custom routes matching location and time criteria of requests. Each driver's vehicle type is checked against all requests in the route. Once processor 21 determines an appropriate route, the route is automatically assigned to a driver and a scheduling table is updated. Processor 21 can utilize all combinations of routing to assign schedules including manual routing. Processor 21 can also utilize a configurable scheduling factor to control the minimum number of requests in a route, which can be directly related to the number of hours in the schedule dispatch. A similar factor exists to control the minimum hours in a schedule. Processor 21 is also configured to identify any requests that were not grouped and/or routed and provide individual dispatching of drivers to handle these requests or manually group these requests in existing groups.

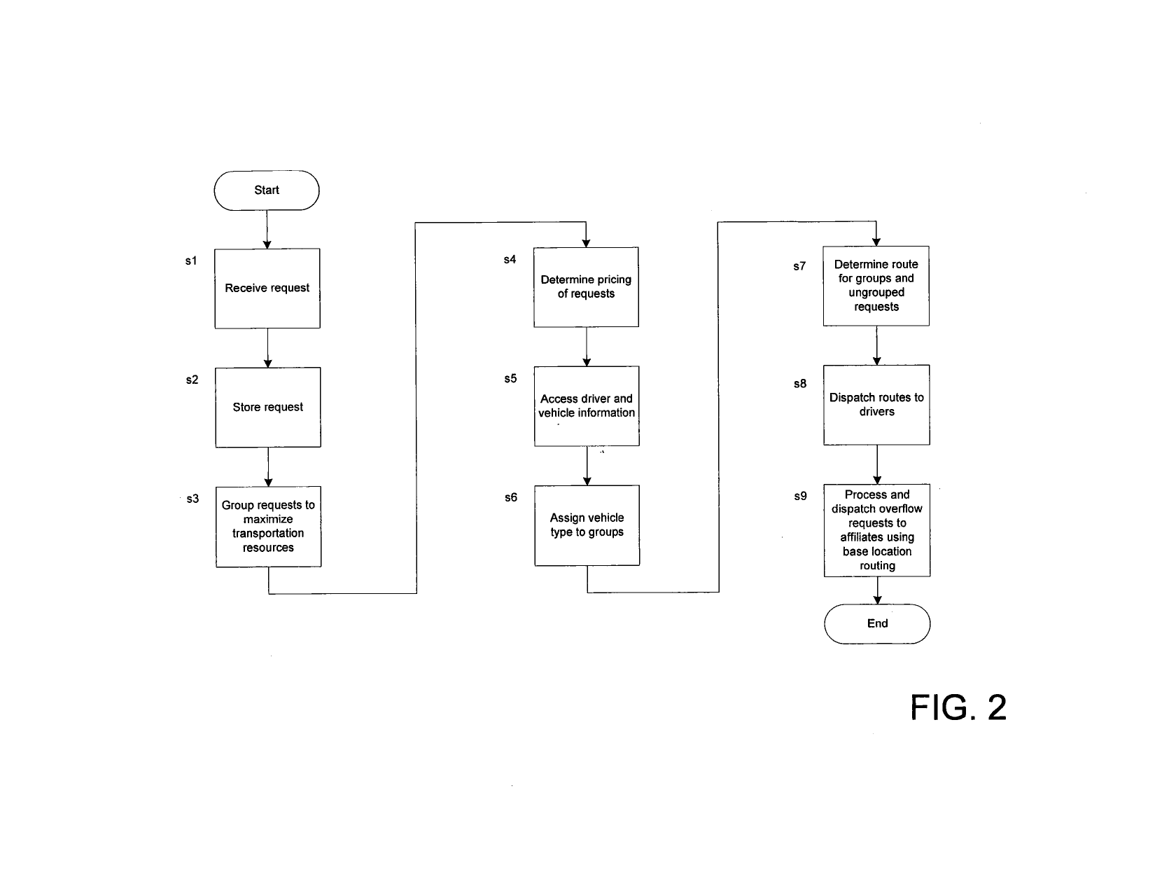

Methods for optimizing transportation resources will now be described with reference to FIGS. 2-5.

Turning now to FIG. 2, a process for optimizing transportation resources will now be described. In step s1 processor 21 receives a plurality of requests to pick up at a pick up location and drop off at a destination at least one item per request. In step s2 processor 21 stores the request in memory 22. In step s3 processor 21 determines requests to be grouped in a vehicle to maximize at least one of vehicle resources and driver resources. As stated above, each request can include a client ID, a pick up time, the pick up location, a drop off time, the drop off destination, and a number of passengers. Other request information is contemplated.

In step s4 processor 21 determines price zones based of the pick up location and the drop off destination, and prices the requests based on the determined price zones. It is contemplated that processor 21 can convert the pick up location and drop off destination to Global Positioning System (GPS) coordinates. The GPS coordinates can be utilized during any subsequent processing as needed.

In step s5 processor 21 reads driver and vehicle information from memory 22. It is contemplated that the driver information can include a driver start location, a driver start time, a driver end time, a car ID, client restrictions (e.g. a client requests a specific driver or requests not to be assigned to a specific driver), etc. It is also contemplated that the vehicle information can include the number of passengers a vehicle can accommodate, client restrictions (e.g. a client requests a specific vehicle type or requests not to be assigned to a specific vehicle type), etc.

In step s6 processor 21 assigns a vehicle type to the groups based on total number of passengers a vehicle can accommodate. This process can include accommodating schedules previously submitted by drivers. At this stage processor 21 can also include the total number of driver hours and miles into the assigning process. In step s7 processor 21 determines routes for the groups and ungrouped requests. In step s8 processor 21 dispatches the routes to the drivers. In step s9 processor 21 processes and dispatched overflow requests to affiliates using base location routing.

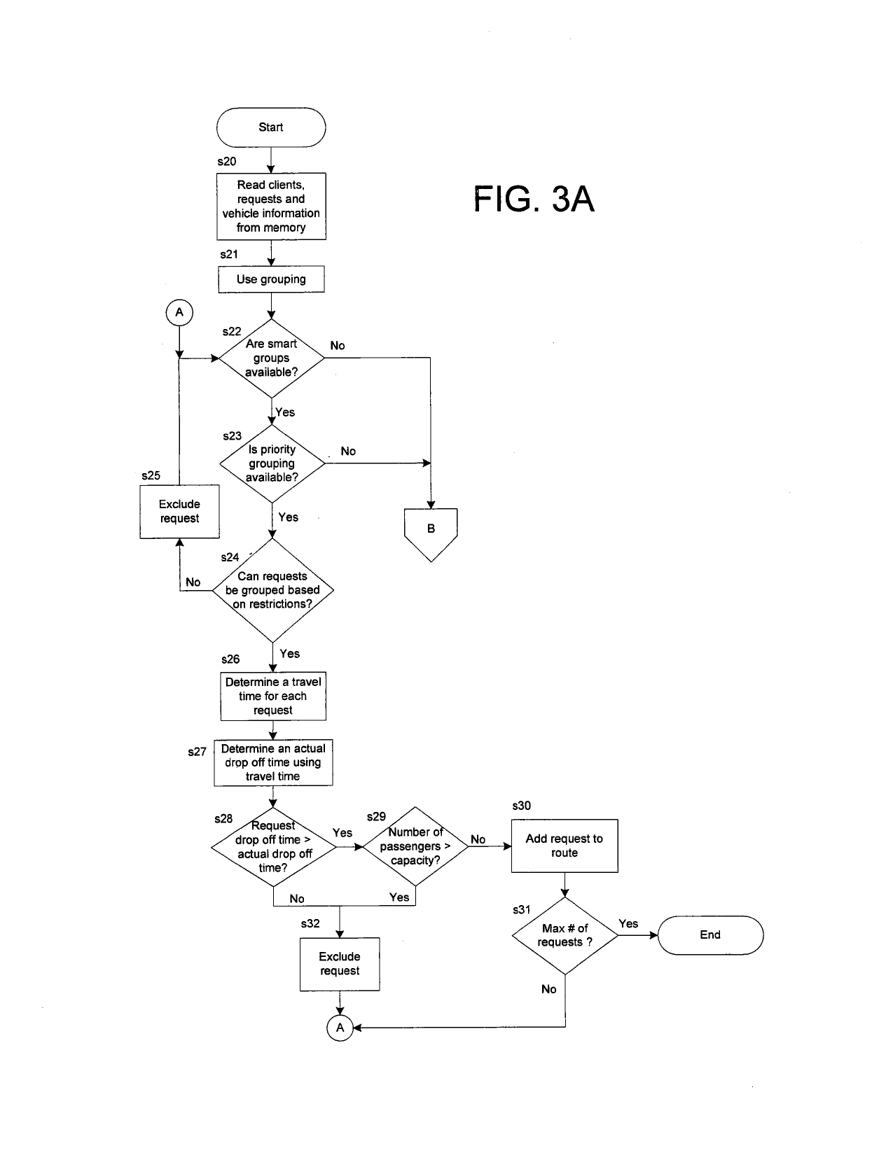

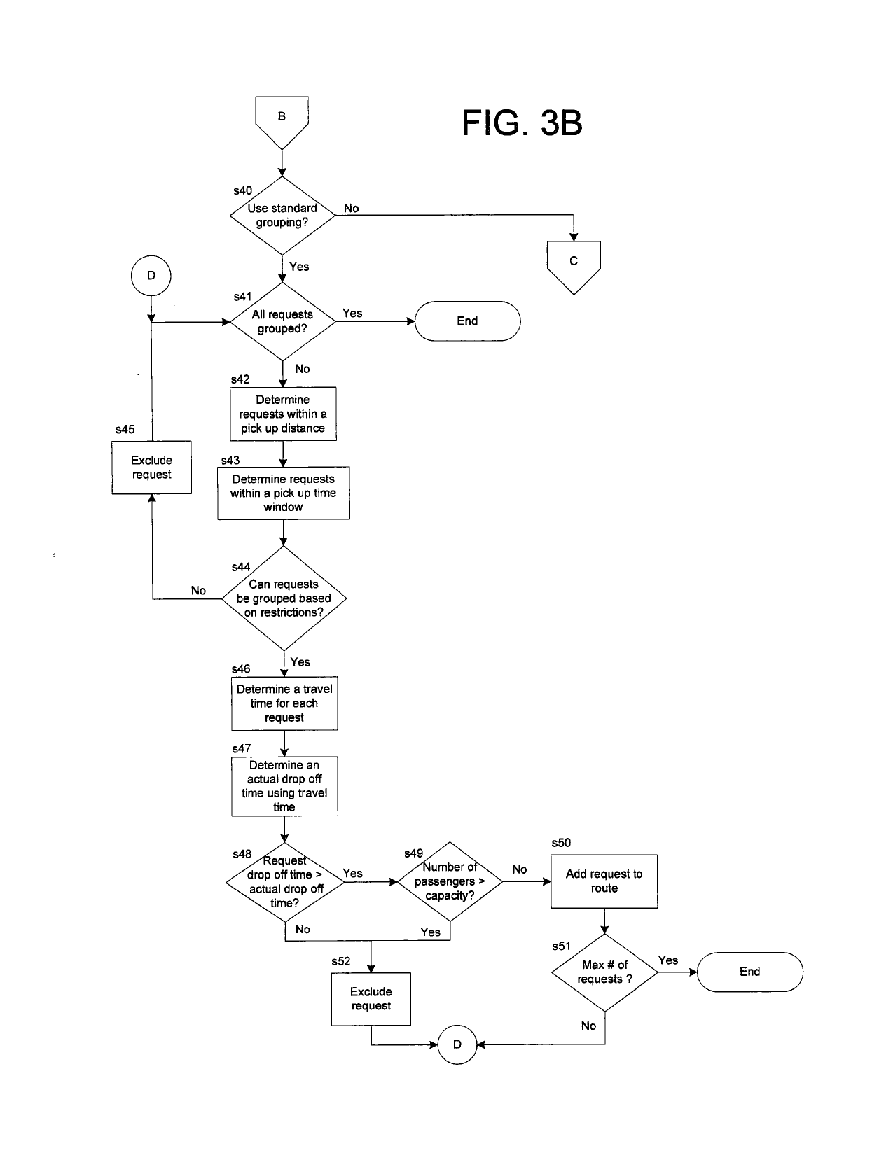

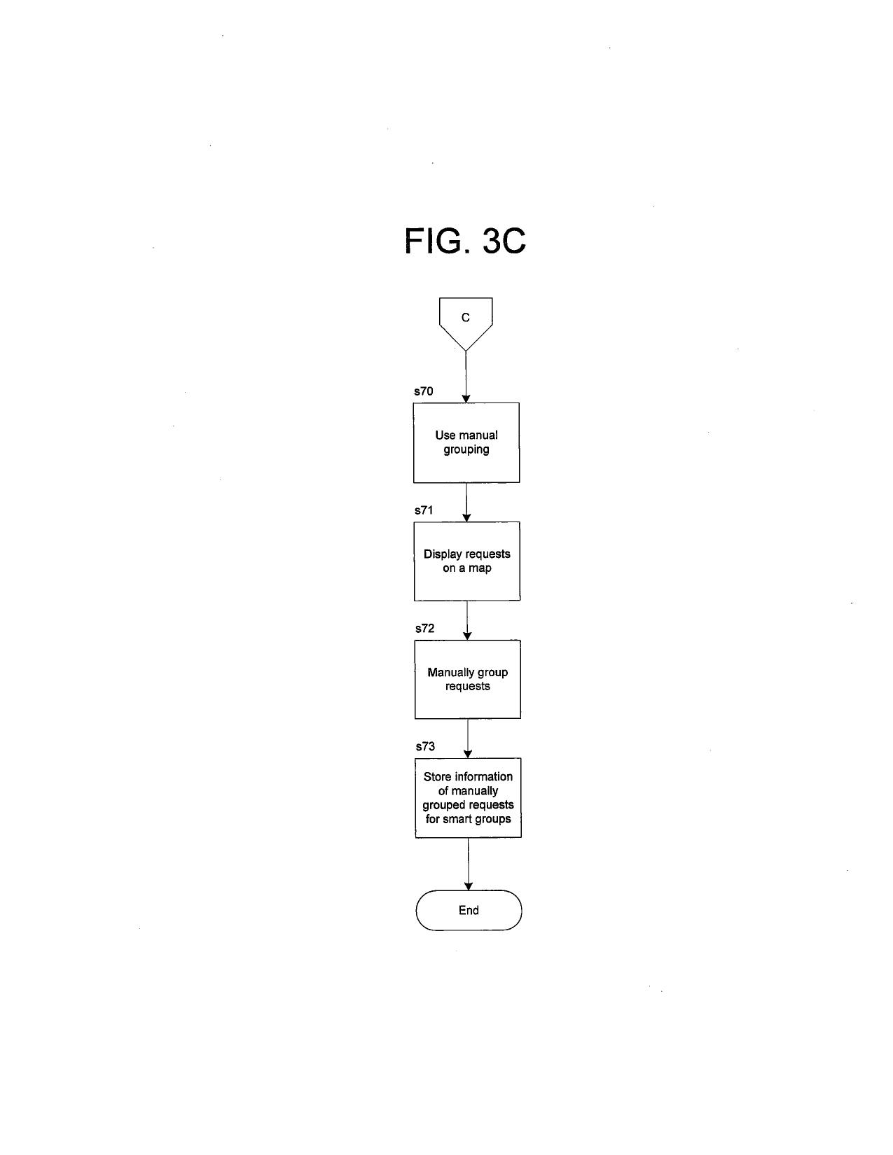

Turning now to FIGS. 3A, 3B and 3C, a process for grouping requests will now be described. In step s20 processor reads client information, request information and vehicle information from memory 22. In step s21 processor 21 begins the grouping process. It is noted that a client may submit a request having two or more parts, e.g. both a morning request and an evening request, such as a commuter. Each part of the request is treated as a separate request for grouping purposes. This is done in order to account for the fact that even though a first part can be grouped with another request, the second part might not fit the same grouping. For example, although client A and B live near each other and are picked up together in the morning (i.e. grouped) and dropped off, the evening pick up distance or times might warrant a different grouping.

In step s22 processor 21 determines if smart groups are available. If not, the process continues to FIG. 3B. If smart groups are available, in step s23 processor 21 determines if priority grouping is available. If not, the process continues to FIG. 3B.

If priority grouping is available, in step s24 processor 21 determines if requests can be grouped based on client restrictions. If the requests cannot be grouped, in step s25 the request is excluded from the group. If the requests can be grouped, in step s26 processor 21 determines a travel time required to travel to the pick up locations and drop off destinations of the requests within the threshold distance and within the threshold time window. In step s27 processor 21 determines an actual time by adding the travel time to an estimated start time. The earliest pick up time of requests being processed can be used as the estimated start time; other estimated start times are contemplated. In step s28 processor 21 determines if requests have drop off times that exceed the actual time. If a drop off time of a request does not exceed the actual time (i.e. actual time is later that request drop off time), in step s32 processor 21 excludes the request from the grouping. If the drop off time of the request exceeds the actual time (i.e. actual time earlier than request drop off time), in step s29 processor 21 determines if the number of passengers of the request exceeds a remaining capacity of a vehicle. If the number of passengers exceeds the capacity, in step s32 processor 21 excludes the request from the group. If the number of passengers does not exceed the capacity, in step s30 processor 21 adds the request to the route. Then, in step s31 processor 21 determines if the maximum number of requests per route has been reached. If the maximum number of requests for the route has been reached, the process ends. If the maximum number of requests for the route has not been reached, the process returns to step s22.

If no smart groups are available or if priority grouping is not available, in step s40 processor 21 determines standard grouping is to be used. If standard grouping is not used, the process performs manual grouping of FIG. 3C.

If standard grouping is to be used, in step s41 processor 21 determines if all of the requests have been grouped. If so, the process ends. If not all of the requests have been grouped, in step s42 processor 21 determines requests that are within a specified distance from each other. In step s43 processor 21 determines requests having pick up times that are within a specified pick up time window of each other. Then in step s44 processor 21 determines if requests can be grouped based on client restrictions. If the requests cannot be grouped, in step s45 the request is excluded from the group. If the requests can be grouped, in step s46 processor 21 determines a travel time required to travel to the pick up locations and drop off destinations of the requests within the threshold distance and within the threshold time window. In step s47 processor 21 determines an actual time by adding the travel time to an estimated start time. The earliest pick up time of requests being processed can be used as the estimated start time; other estimated start times are contemplated. In step s48 processor 21 determines if requests have drop off times that exceed the actual time. If a drop off time of a request does not exceed the actual time (i.e. actual time is later that request drop off time), in step s52 processor 21 excludes the request from the grouping. If the drop off time of the request exceeds the actual time (i.e. actual time earlier than request drop off time), in step s49 processor 21 determines if the number of passengers of the request exceeds a remaining capacity of a vehicle. If the number of passengers exceeds the capacity, in step s52 processor 21 excludes the request from the group. If the number of passengers does not exceed the capacity, in step s50 processor 21 adds the request to the route. Then, in step s51 processor 21 determines if the maximum number of requests per route has been reached. If the maximum number of requests for the route has been reached, the process ends. If the maximum number of requests for the route has not been reached, the process returns to step s41.

During any of the above grouping processes, processor 21 can also apply special requirements as set forth above, such as excluding clients that require a particular vehicle, etc. It is also contemplated that several or all of the grouping methods can be utilized during a grouping process. For example, a priority grouping can be used first, followed by a smart grouping, followed by a standard grouping, and finalized by a manual grouping.

If the standard grouping is not used, in step s70 processor 21 uses manual grouping. In step s71 processor 21 displays requests on a map. In step s72 a dispatcher manually groups requests. In step s73 the manually grouped requests are identified as grouped and stored for subsequent smart grouping processes.

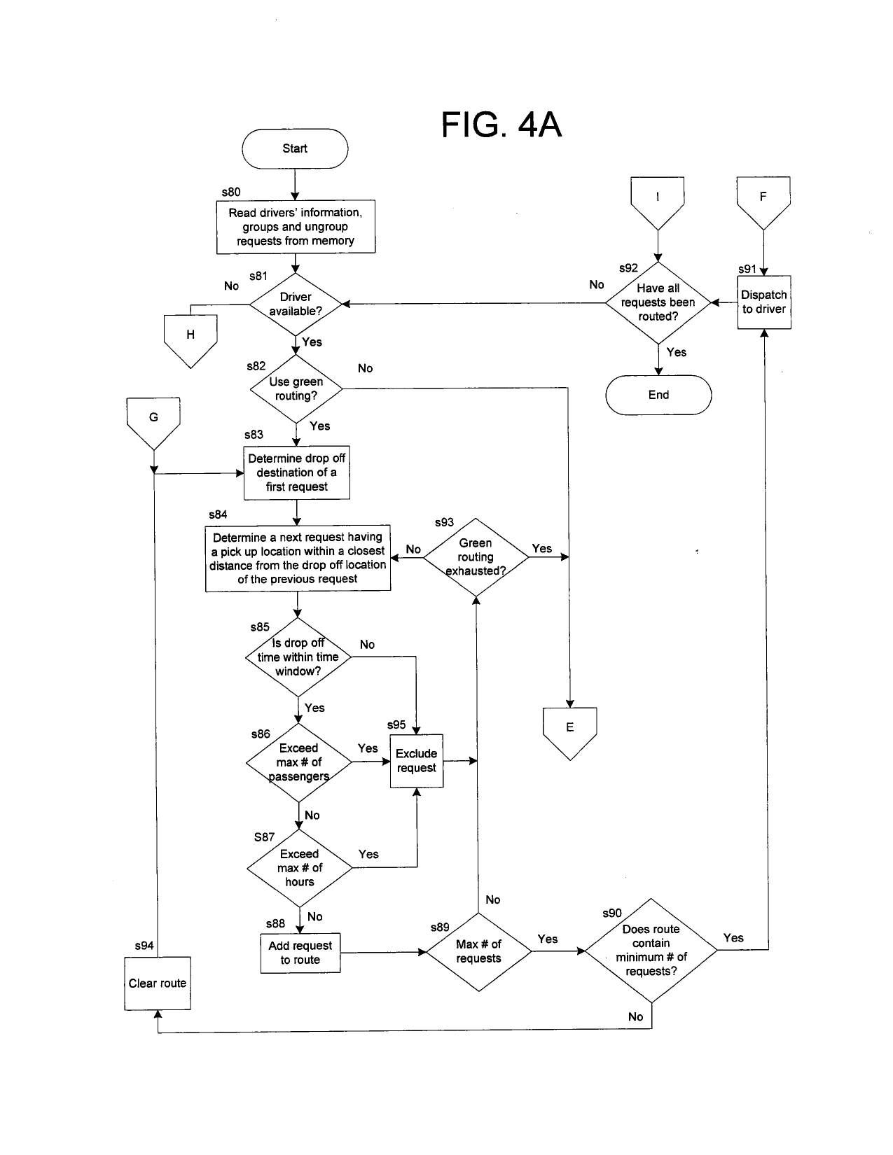

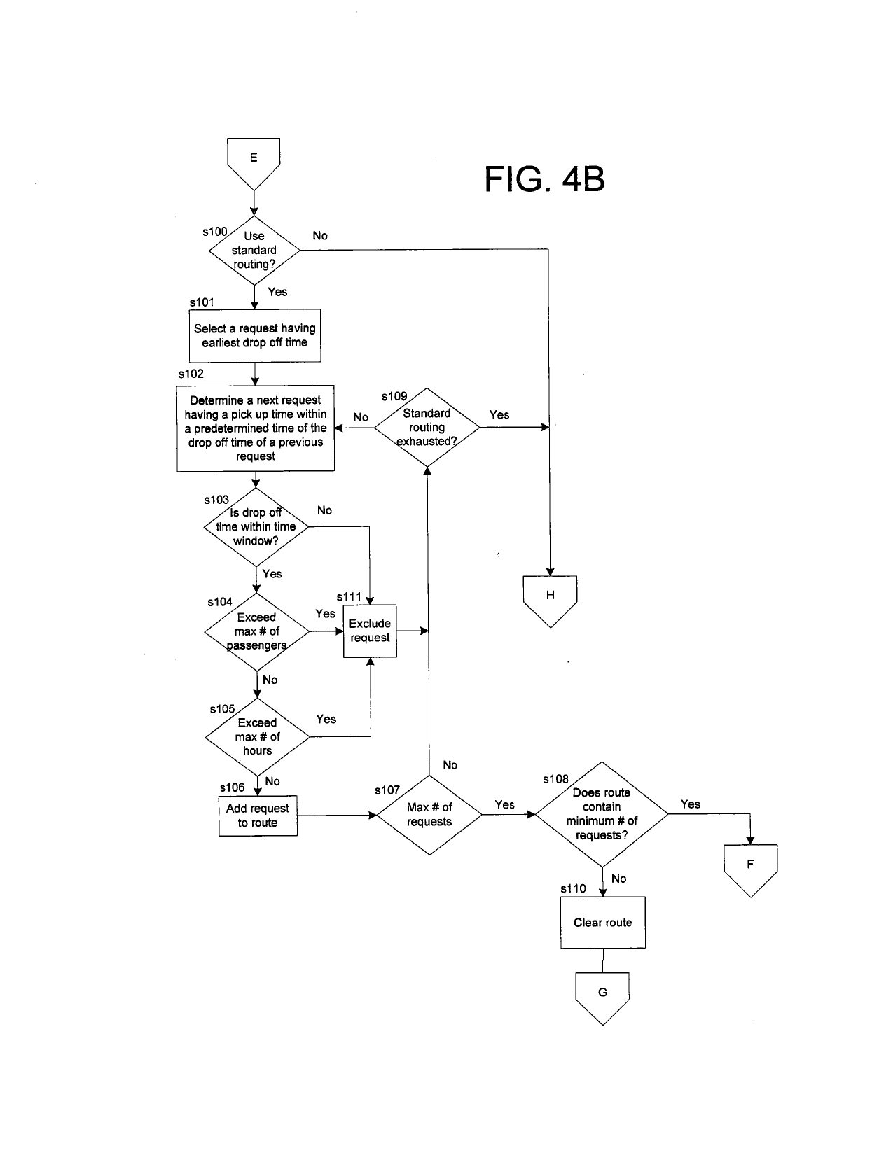

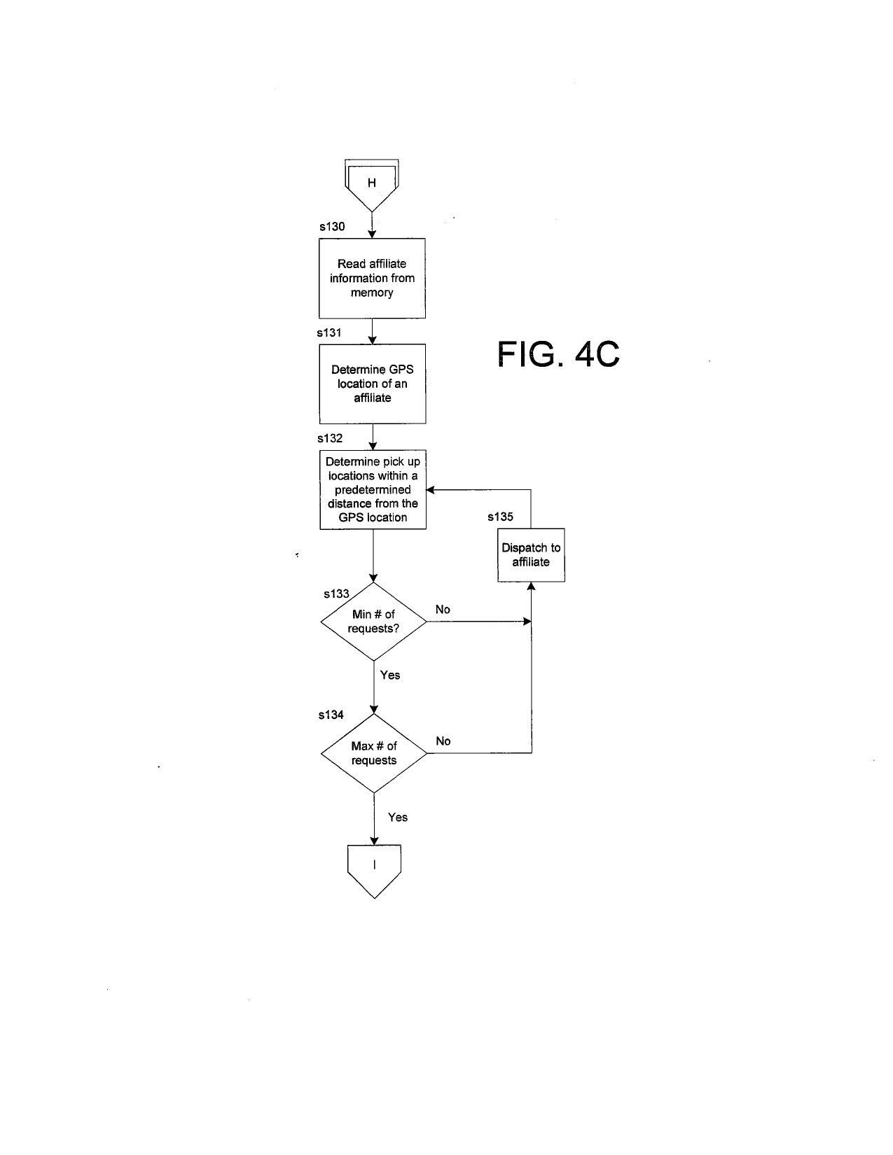

Turning now to FIGS. 4A, 4B and 4C, a process for routing requests will be described. In step s80 processor 21 reads drivers' information, groups and ungrouped requests from memory 22. In step s81 processor 21 determines if a driver is available to have routes dispatched to. If no drivers are available, the process continues to FIG. 4C to dispatch requests to affiliates. If at least one driver is available, in step s82 processor 21 determines if green routing is to be used. If green routing is not being used, the process continues to FIG. 4B.

If green routing is being used, in step s83 processor 21 determines a drop off destination of a first request. In step s84 processor 21 determines a next request having a pickup location closest to the drop off location of the previous request. As stated above, a request in the group having the earliest pick up time can be used as a first request; others are contemplated.

In step s85 processor determines if the drop off time is within a specified time window, i.e. can passenger be dropped off by or before the requested drop off time. If not, in step s95 the request is excluded from the route. It is noted that the time window can be adjusted to account for variations. Such variations can include delay factors such as traffic and/or weather conditions. The adjustable windows (or parameters) are available for all similar processes in the system. For example, the number of passengers per vehicle can be adjustable, the number of requests per route can be adjustable, the number of requests per affiliate can be adjustable, time based parameters/windows can be adjustable, etc. Other parameters/windows subject to adjustment are contemplated.

If the drop off time is within the window, in step s86 processor 21 determines if the maximum number of passengers is exceeded, i.e. vehicle type cannot accommodate number of passengers in request in and of itself or in combination with previously requests already included in the route. If exceeded, in step s95 the request is excluded. If not exceeded, in step s87 processor 21 determines if a maximum number of hours for a driver has been exceeded, i.e. either a preset maximum for drivers in general or a number of hours a particular driver is available. If the maximum number of hours is exceeded, in step s95 the request is excluded. If the maximum number of hours is not exceeded, in step s88 processor 21 adds the request (or group) to the route. In step s89 processor 21 determines if the maximum number of requests per route has been reached. If not, in step s93 processor 21 determines if the green routing has been exhausted, i.e. if all requests have been subjected to the green routing process. It is also noted that if the request is excluded in step s95, the process also continues to step s93 to determine if the green routing has been exhausted. If the green routing has not been exhausted, the process returns to s84 to select another request. If the green routing is exhausted, the process goes to FIG. 4B.

If in step s89 it is determined that the maximum number of requests has been reached, in step s90 processor 21 determines if a route contains a minimum number of requests. If not, in step s94 the entire route is cleared and the process returns to step s83. if the route does contain a minimum number of requests, in step s91 the route is dispatched to the driver. In step s92 processor 21 determines if all requests (and/or groups) have been dispatched. If not, the process returns to s81. If all requests have been routed, the process ends.

In step s100 processor 21 determines if standard routing is to be used. If standard routing is not being used, the process continues to FIG. 4C.

If standard routing is being used, in step s101 processor 21 determines a drop off time of a first request. In step s102 processor 21 determines a next request having a pickup time within a predetermined time of drop off time of the previous request. As stated above, a request in the group having the earliest pick up time can be used as a first request; others are contemplated.

In step s103 processor determines if the drop off time is within a specified time window, i.e. can passenger be dropped off by or before the requested drop off time. If not, in step s111 the request is excluded from the route. If the drop off time is within the window, in step s104 processor 21 determines if the maximum number of passengers is exceeded, i.e. vehicle type cannot accommodate number of passengers in request in and of itself or in combination with previously requests already included in the route. If exceeded, in step s111 the request is excluded. If not exceeded, in step s105 processor 21 determines if a maximum number of hours for a driver has been exceeded, i.e. either a preset maximum for drivers in general or a number of hours a particular driver is available. If the maximum number of hours is exceeded, in step s111 the request is excluded. If the maximum number of hours is not exceeded, in step s106 processor 21 adds the request (or group) to the route. In step s107 processor 21 determines if the maximum number of requests per route has been reached. If not, in step s109 processor 21 determines if the standard routing has been exhausted, i.e. if all remaining requests have been subjected to the standard routing process. It is also noted that if the request is excluded in step s111, the process also continues to step s109 to determine if the standard routing has been exhausted. If the standard routing has not been exhausted, the process returns to s102 to select another request. If the standard routing is exhausted, the process goes to FIG. 4C.

If in step s107 it is determined that the maximum number of requests has been reached, in step s108 processor 21 determines if a route contains a minimum number of requests. If not, in step s110 the entire route is cleared and the process returns to step s83. It is noted that if the green and/or standard routing processes individually cannot product enough routes, in addition to modifying the parameters/windows, the system can utilize a combination or hybrid green and standard routing process. This can be accomplished by alternating the green routing process and the standard routing process. For example, the system can route 2 requests using green routing and then add (i.e. route) 1 request using standard routing, and continue until all requests are routed. Other variations are contemplated.

If the route does contain a minimum number of requests, in step s91 the route is dispatched to the driver. In step s92 processor 21 determines if all requests (and/or groups) have been dispatched. If not, the process returns to s81. If all requests have been routed, the process ends.

If no drivers are available in step s81, if standard routing is not being used in step s100 or if standard routing is exhausted in step s109 the process relies on affiliates to fill requests in the base location routing process. In step s130 processor 21 reads affiliate information from memory 22. This information can contain minimum and maximum numbers of requests to dispatch to each affiliate as well as client restrictions relating to whether a client can be dispatched to that particular affiliate. In step s131 processor 21 determines a GPS location of an affiliate. In step s132 processor 21 determines pick up locations of requests within a predetermined distance from the GPS location. In step s133 processor 21 determines if a minimum number of requests for that affiliate has been reached. If not, in step s135 the request is dispatched to the affiliate and the process returns to step s132. If the minimum number of requests has been reached, in step s134 processor 21 determines if a maximum number of requests has been reached. If not, in step s135 the request is dispatched to the affiliate. If the maximum number of requests has been reached for the affiliate, the process returns to step s92. In step s92 processor 21 determines if all requests (and/or groups) have been dispatched. If not, the process returns to s81. If all requests have been routed, the process ends.

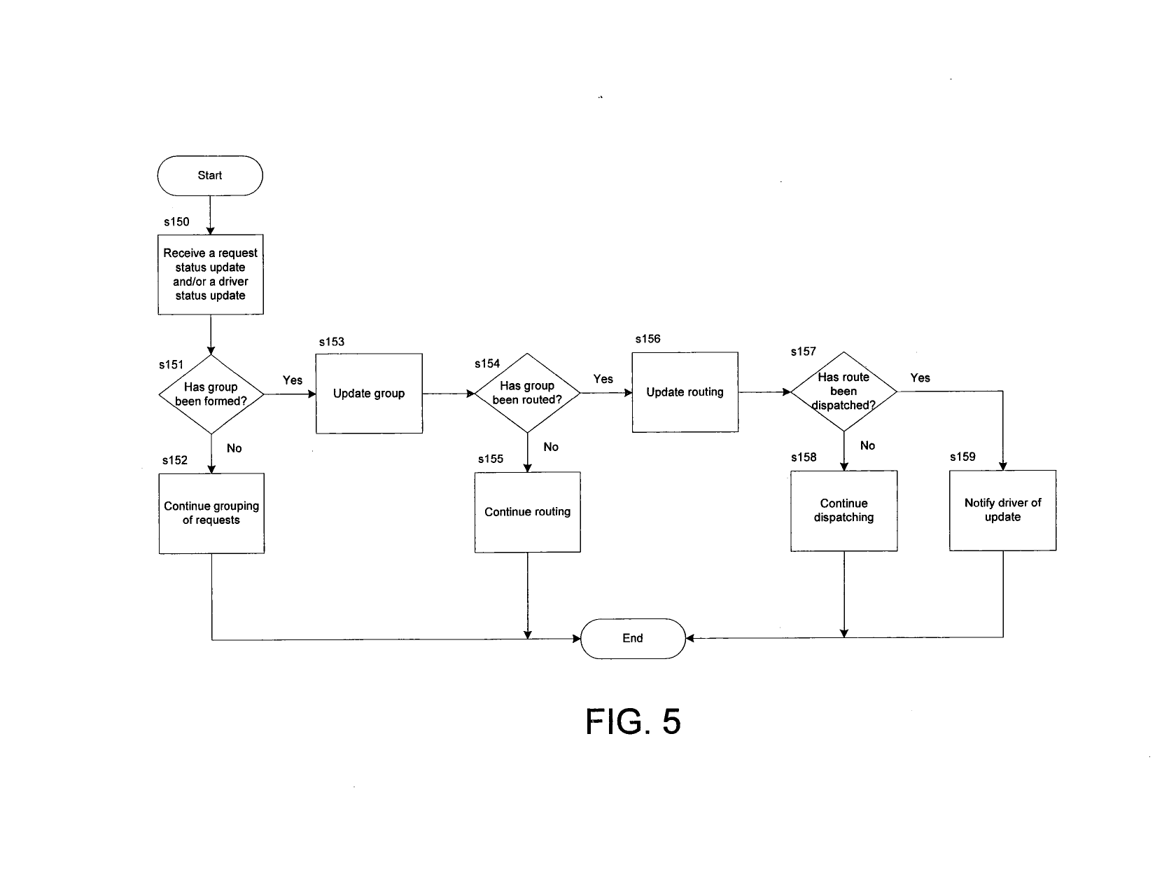

Turning now to FIG. 5, a process for updating a status of a request will now be described. In step s150 processor 21 receives a request status update and/or a driver status update. A request status update can include, for example, a time change, a location change or a cancellation; other status updates are contemplated. A driver status update can include, for example, a notification by a driver that he is being delayed and will not be able to meet the request requirements in his route, or that the driver can work late and thus handle more requests. In step s151 processor 21 determines if a group has been formed containing the updated request. If a group has not been formed, in step s152 processor 21 continues the grouping process with the updated request information. If a group has been formed, in step s153 processor 21 updates the request in the group with the updated request information. In step s154 processor 21 determines if a group has been routed. If a group has not been routed, in step s155 processor 21 continues the routing process with the updated request information. If the group has been routed, in step s156 processor 21 updates the routing with the updated request information. In step s157 processor 21 determines if a route has been dispatched. If the route has not been dispatched, in step s158 processor 21 continues the dispatching process with the updated request information. If the route has been dispatched, in step s159 processor 21 notifies the driver of the updated request. The notification can be of any known methods, for example, a text message, and email, a voice call, etc.

As described herein, the present invention provides systems and methods for optimizing resources in ground transportation ride sharing. In addition, the present disclosure envisions a computer program device readable by a machine, tangibly embodying a program of instructions executable by the machine to perform methods disclosed herein.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

1. A method for optimizing transportation resources, comprising the steps of:
receiving, by a processor, a plurality of requests to pick up at a pick up location and drop off at a destination at least one item per request;
storing the requests in a memory;
determining, by the processor, requests to be grouped in a vehicle to maximize at least one of vehicle and driver resources;
reading client restrictions from the memory; and
excluding requests based on the client restrictions,
wherein each request includes a pick up time, the pick up location, a drop off time, the drop off destination, and a number of items and/or passengers,
wherein each request includes a pick up time and a drop off time and the grouping, by the processor, further comprises:
determining, by the processor, requests within a threshold pick up distance from each other;
determining, by the processor, requests within the threshold distance having pick up times within a threshold time window;
determining, by the processor, a travel time required to travel to the pick up locations and drop off destinations of the requests within the threshold distance and within the threshold time window;
determining, by the processor, an actual time by adding the travel time to an estimated start time;
determining, by the processor, requests having drop off times later than the actual time; and
routing, by the processor, requests having drop off times later than the actual time.

2. (canceled)

3. The method of claim 1, further comprising:
determining, by the processor, price zones of the pick up location and the drop off destination; and
calculating, by the processor, a price for the request based on the determined price zones.

4. The method of claim 1, further comprising converting, by the processor, the pick up location and drop off destination to Global Positioning System (GPS) coordinates.

5. (canceled)

6. The method of claim 1, wherein each request includes a number of passengers to be picked up and dropped off, the method further comprising:
determining, by the processor, a total number of passengers of the routed; and
excluding, by the processor, a request if the total number of passengers exceeds a vehicle capacity.

7. (canceled)

8. The method of claim 1, further comprising:
determining a number of grouped requests;
determining if the number of grouped requests exceeds a threshold; and
finalizing a group when the number of grouped requests is greater than the threshold.

9. The method of claim 1, wherein the maximizing of the vehicle resources is based on at least one of a travel time of a group of requests and a travel distance of a group of requests.

10. The method of claim 1, wherein the maximizing of the driver resources is based on at least one of a number of requests, a travel time of a group of requests, a travel distance of a group of requests, a total driving time of a driver, and a total driving distance of a driver.

11. The method of claim 1, further comprising:
determining if at least two requests have been previously grouped; and
grouping previously grouped requests.

12. The method of claim 1, wherein each request includes a number of passengers to be picked up and dropped off, wherein the grouping further comprises:
displaying pick up locations and drop off destinations of the requests on a map; determining requests to be grouped based on the displayed pick up locations and drop off destinations;
assigning a vehicle type capable of transporting the total number of passengers; and
excluding requests based on client restrictions.

13. The method of claim 1, further comprising:
receiving, by the processor, a status update; and
updating, by the processor, the group based on the status update.

14. The method of claim 1, further comprising routing, by the processor, a delivery route for a plurality of requests.

15. The method of claim 14, wherein the routing is based on minimizing a travel time required to complete the plurality of requests.

16. The method of claim 14, wherein the routing is based on minimizing a travel distance required to complete the plurality of requests.

17. The method of claim 14, wherein the routing further comprises:
a) selecting from the plurality of requests a first request having an earliest drop off time;
b) determining a next request having a pick up time within a predetermined time window of a drop off time of a previous request;
c) routing the requests; and
d) repeating steps b and c until all requests have been routed.

18. The method of claim 17, further comprising excluding requests that are determined to exceed preset parameters.

19. The method of claim 16, wherein the routing further comprises:
a) selecting from the plurality of requests a first request having a closest drop off destination;
b) determining a next request having a pick up location within a predetermined distance from a drop off destination of a previous request;
c) routing the requests; and
d) repeating steps b and c until all requests have been routed.

20. The method of claim 19, further comprising excluding requests that are determined to exceed preset parameters.

21. The method of claim 14, wherein the routing further comprises:
a) determining a GPS location of an affiliate;
b) determining pick up locations of requests within a predetermined distance from the GPS location;
c) dispatching the determined requests to the affiliate; and
c) repeating steps a, b and c until all requests have been routed.

22. A system for optimizing transportation resources, comprising:
a processor configured to receive a plurality of requests to pick up at a pick up location and drop off at a destination at least one item per request and determine requests to be grouped in a vehicle to maximize at least one of vehicle and driver resources; and
a memory configured to store the requests, the determined groups, vehicle information and driver information,
wherein each request includes a pick up time, the pick up location, a drop off time, the drop off destination, and a number of items and/or passengers, and
wherein the processor is further configured to determine requests within a threshold pick up distance from each other, determine requests within the threshold distance having pick up times within a threshold time window, determine a travel time required to travel to the pick up locations and drop off destinations of the requests within the threshold distance and within the threshold time window, determine an actual time by adding the travel time to an estimated start time, determine requests having drop off times later than the actual time, and routing requests having drop off times later than the actual time.

23. (canceled)

24. The system of claim 22, wherein the processor is further configured to determine price zones of the pick up location and the drop off destination and calculate a price for the request based on the determined price zones.

25. The system of claim 22, wherein the processor is further configured to convert the pick up location and drop off destination to Global Positioning System (GPS) coordinates.

26. (canceled)

27. The system of claim 22, wherein each request includes a number of passengers to be picked up and dropped off, and wherein the processor is further configured to determine a total number of passengers of the routed requests, and excluding a request if the total number of passengers exceeds a vehicle capacity.

28. The system of claim 27, wherein the processor is further configured to read client restrictions from the memory and to exclude requests based on the client restrictions.

29. The system of claim 22, wherein the processor is further configured to determine a number of grouped requests, determine if the number of grouped requests exceeds a threshold, and finalize a group when the number of grouped requests is greater than the threshold.

30. The system of claim 22, wherein the maximizing of the vehicle resources is based on at least one of a travel time of a group of requests and a travel distance of a group of requests.

31. The system of claim 22, wherein the maximizing of the driver resources is based on at least one of a number of requests, a travel time of a group of requests, a travel distance of a group of requests, a total driving time of a driver, and a total driving distance of a driver.

32. The system of claim 22, wherein the processor is further configured to determine if at least two requests have been previously grouped, and grouping previously grouped requests.

33. The system of claim 22, wherein each request includes a number of passengers to be picked up and dropped off, and wherein the processor is further configured to display pick up locations and drop off destinations of the requests on a map, determine requests to be grouped based on the displayed pick up locations and drop off destinations, assign a vehicle type capable of transporting the total number of passengers, and exclude requests that prohibit transportation in the assigned vehicle type.

34. The system of claim 22, wherein the processor is further configured to receive a status update, and update the group based on the status update.

35. The system of claim 22, wherein the processor is further configured to route a delivery route for a plurality of requests.

36. The system of claim 35, wherein the routing is based on minimizing a travel time required to complete the plurality of requests.

37. The system of claim 35, wherein the routing is based on minimizing a travel distance required to complete the plurality of requests.

38. The system of claim 37, wherein the processor is further configured to:
a) select from the plurality of requests a first request having an earliest drop off time;
b) determine a next request having a pick up time within a predetermined time window of a drop off time of a previous request,
c) route the requests, and
d) repeat steps b and c until all requests have been routed.

39. The system of claim 38, wherein the processor is further configured to exclude requests that are determined to exceed preset parameters.

40. The system of claim 35, wherein the processor is further configured to:
a) select from the plurality of requests a first request having a closest drop off destination;
b) determine a next request having a pick up location within a predetermined distance from a drop off destination of a previous request,
c) route the requests, and
d) repeat steps b and c until all requests have been routed.

41. The system of claim 40, wherein the processor is further configured to exclude requests that are determined to exceed preset parameters.

42. The system of claim 35, wherein the processor is further configured to:
a) determine a GPS location of an affiliate;
b) determine pick up locations of requests within a predetermined distance from the GPS location;
c) dispatch the determined requests to the affiliate; and
d) repeat steps a, b and c until all requests have been routed.

43. (canceled)

44. (canceled)
